(19) United States
(12) Patent Application Publication
(10) Pub. No.: US 2021/0254407 A1
(43) Pub. Date: Aug. 19, 2021

(54) Ladder Stabilizer Apparatus

(71) Applicant: Henry Arthur Elmore, Mobile, AL (US)

(72) Inventor: Henry Arthur Elmore, Mobile, AL (US)

(21) Appl. No.: 16/792,349

(22) Filed: Feb. 17, 2020

(51) Int. Cl. E06C 7/48

(52) U.S. Cl. CPC E06C 7/48; E06C 1/12

(57) ABSTRACT

A ladder stabilization apparatus that when fully deployed will change the characteristics of an extension ladder, as well as the technique used by the ladder user when accessing an elevated platform or roof. This apparatus will improve stabilization, will allow the ladder to be attached at its top to the elevated platform or roof, and will extend the top of the ladders rail, all in such a way that the ladder user will be able to transition to the platform or roof, by stepping over the ladders top rung, directly onto the platform or roof. This apparatus is compact and light in weight and permanently installs on the ladder. The core components of the invention are left & right Arm assemblies, left and right Clamp assemblies, and ladder Extension. Configuration is as follows: Arm assemblies mount directly to ladder, locate the self-adjusting feet on the platform or roof. The Clamp assemblies that are attached to the Arm assemblies by a very short chain, secure the top of the ladder to the platform or roof. The Extension mounts to the top portion of the ladders rail, and in effect, serves to extend the ladders rail.

### BACKGROUND OF INVENTION

### Field of Invention

This ladder stabilization apparatus is in the field of ladder stabilization devices that attach to the upper end of an extension ladder, with the objectives of: Stabilizing the ladder. Allowing the ladder to standoff the structure. Provide top of ladder attachment, to the platform or roof. And provide an extension to top of the ladders rail.

### History

Many ladder users simply lean the ladder against the house with no safety or securing device whatsoever, due to the available devices being: too bulky and or heavy, setup and take down is to complicated, to difficult, to time consuming, or ladder & device become separated. With no safety or securing device the ladder is inherently unstable and can easily cause damage to the gutter system and or roofing system.

Additionally, many ladder users use nothing more than a bungee cord or rope to tie off their ladder. This method will prevent a ladder blow over, provided there is an attachment point for the bungee, however, does little for stability, and nothing to prevent damage or increase safety. Neither of the above mentioned methods provide the ladder user a way to transition to and from an elevated platform, such as a roof, without the ladder users core body weight being outside the rails of the ladder and creating both ladder instability and balance issues for the ladder user.

### RELATED ART OVERVIEW

Currently there are a number of solutions for stabilizing a ladder that have a US patent Number. Most of these devices do not allow for securing the ladder to the structure. Some of these devices are big and heavy in construction. Some are not permanently installed on the ladder. Some do not allow the ladder to be fully collapsed and or allow device to be functional in the fully collapsed position. Some are complicated, requiring tools and time-consuming setup and or adjustment upon each use. Some do not allow the ladder user to remain within the ladder rails on transition to and from an elevated platform. Some do not prevent damage to structure. Some are not in harmony with recognized procedures concerning safe ladder use.

All the devices known by this inventor, incorporate more than one of these deficiencies. Therefore, there currently exists a need in industry for a device that is permanently attached to the ladder, that is light in weight, that is compact in size, that will secure the ladder at its top to the platform or roof, that will increase user safety, that will not cause damage, that will allow the ladder user to remain in the center of the ladder on transition to and from an elevated platform, that will allow full usability in all ranges of the ladders fly section including fully collapsed, that cannot be misplaced or separated from the ladder, all while being simple and easy to use.

### RELATED ART

U.S. Pat. No. 6,009,974, Jones, 2000
U.S. Pat. No. 5,383,533, Nikula, 1995
U.S. Pat. No. 4,061,203, Hinsdale, 1977
U.S. Pat. No. 8,235,175, Feldhaus, 2012
U.S. Pat. No. 8,752,672, Turner, 2014
U.S. Pat. No. 7,377,360, Misiak, 2008
U.S. Pat. No. 9,932,771, Bramwell, 2018
U.S. Pat. No. 8,607,932, Cooper, 2013
U.S. Pat. No. 5,941,343, Kelsey, 1999
U.S. Pat. No. 6,681,893, Coulson, 2004
U.S. Pat. No. 6,394,229, Hastreiter, 2002
U.S. Pat. No. 5,165,501, Donahey, 1992

### OBJECTS OF THE INVENTION

It is an object of this invention to provide an apparatus that is permanently mounted, simple, compact, light in weight, and easy to use.

It is an object of this invention to provide an apparatus that allows the ladders top to be secured to the platform or roof.

It is an object of this invention to provide an apparatus that will allow the ladder user to access a roof without causing damage to shingles and or gutters.

It is an object of this invention to provide an apparatus that will allow the ladder user to easily step over the top rung, directly onto the roof surface while keeping his core body weight in the center of the ladder and Arm assemblies.

It is an object of this invention to provide an apparatus allowing the ladder to be stowed and transported without the need for removal.

It is an object of this invention to provide an apparatus that will maintain its functionality throughout the range of the ladders fly section, including fully collapsed.

It is an object of this invention to provide an apparatus that will effectively add an additional 2′ of usability to the ladder.

It is an object of this invention is to provide an apparatus that is in harmony with recognized procedures concerning safe ladder use.

A further object of this invention is to provide a device that does not suffer from the deficiencies associated with prior solutions.

### SUMMARY OF THE INVENTION

The present invention consists of three assemblies that function in harmony with each other.

The 1st assembly, an Arm assembly, is made up of the following components: a tubular arm, a welded mounting plate, a backing plate, a welded dock, and a self-aligning Foot, this assembly provides ladder stabilization as well as allows the ladder to stand off the roof, so as to not cause damage to the structure. Said assembly consist of a left and right side. The 2^{nd} assembly, a Clamping device, is made up of a Clamp that includes a base plate, a short chain, and hardware, the purpose of said assembly is to attach the top of the ladder to the structures roofing system. Said assembly consist of a left and right side. The 3^{rd} assembly, a ladder Extension device, is made up of a mounting plate, a dock, a base, and an extension, it's purpose is to extend the ladder rail an additional 18″, giving the ladder the needed 3′ above the top of the eave, and providing stability for the ladder user during transition to and from roof.

Configuration of Assemblies: The Arm Assemblies are to be installed on the fly section of the ladder below the top rung. The backing plate to be on the inner of the rail, the mounting plate to be on the outer of the rail. The Arm assemblies are to determine the placement of the Feet, they will include a dock for Clamp storage, and provide attachment locations for the Chains. The purpose of the Feet is to be the point of roof contact for the ladder, so as to do no damage to the shingles or gutters. The Chains are to attach the Clamp assemblies to the mounting plates. The purpose of the Clamp assemblies are to attach the top of the ladder to the roof of the structure. When not in use, the Clamp assemblies will be located on the Clamp storage Dock. The ladder Extension assembly is to attach to the top of the ladders rail above its top rung. The purpose of the ladder Extension assembly is to provide an additional 18″ to the top of the ladders rail.

Summery Wrap-up: The Extension assembly, mounted above the top rung on the ladders rail, provides the recommended 3′ above the eave, and gives the ladder user a needed balance point for added safety and ease of use. The Arm assemblies, mounted below the ladders top rung, not only stabilize the ladder, they allow the ladder to standoff the platform or roof, so as to do no damage to the roofing system or gutters. The Clamp assemblies allow the top of the ladder to be secured to the roof for additional stability and ease of use. With all three assemblies in harmony and fully deployed, this apparatus complies with recognized safety continued on next page standards and allows the ladder user to easily step over the top rung, directly onto the roof surface while keeping his core body weight in the center of the ladder and the Arm Assemblies.

### BRIEF DESCRIPTION OF DRAWINGS

FIG. 1—overview of fully deployed invention with ladder & roof, showing all components

FIG. 2—side overview of fully deployed invention showing only 1 side, with ladder and roof

FIG. 3—overview of compacted invention, with ladder, ready for storage or transport

FIG. 4a—Arm side view with clamp

FIG. 4b—Arm side view with clamp

FIG. 5—Clamp side view

FIG. 6—Foot side view

FIG. 7—deployed Extension side view

FIG. 8—collapsed Extension side view

### DETAILED DESCRIPTION OF DRAWINGS

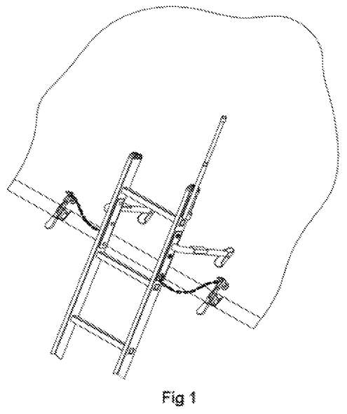

FIG. 1

Fully deployed ladder safety device.

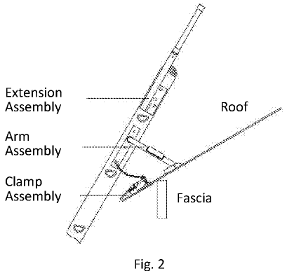

FIG. 2

Fully deployed ladder safety device, side view.

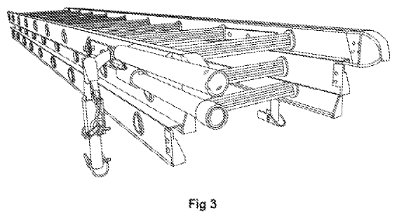

FIG. 3

Fully collapsed ladder & safety device, ready for transport.

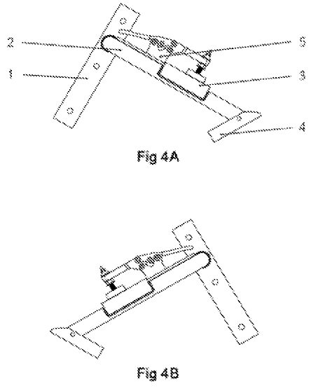

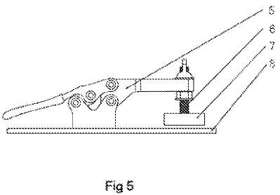

FIGS. 4A & 4B

Arm Assembly FIG. 4 components: the Mounting Plate 1, bolted directly to the ladder fly section, between the top and 2^{nd} rung, of the ladders fly, this location will place the top rung 1′ above the eave. The Mounting Plate fastens on the outside of the fly while the Backing Plate, not shown, mounts on the inside of the fly, these two pieces are what secures the assembly to the ladder, and assure that there is no compromise in structural integrity of the ladder. The tubular Arm 2, it is welded to the Mounting Bracket, is bent in such a way so as to properly locate the Foot 4, welded to said Arm, is the Clamp Dock 3. The Foot, is mounted by a Pin, not shown, to the Arm, is counter balanced so the bottom of said Foot, will dangle significantly below the Pin, so as said Foot will make proper contact with the platform or roof. The Clamp Dock, it is welded to the Arm in a way so as to properly and securely locate the Clamp assembly 5, when the ladder is not in use, and to keep the footprint of the safety device as compact as possible. The Clamp assembly, is attached to the Arm by a short chain, not shown, when not in use it is attached to the Clamp Dock, when in use it is attached to the roofing system.

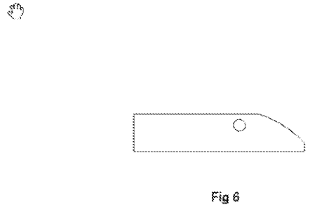

FIG. 5

Side view of Clamp Assy 5, including welded base 8, elevator bolt 6 with pad 7, and attaching hardware.

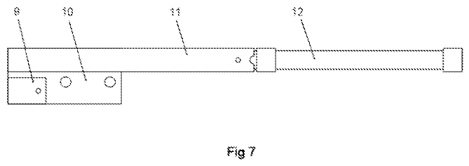

FIG. 6

Side view of Foot.

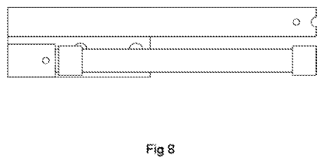

FIG. 7

Deployed Extension assembly: The Mounting Plate 10, fastens to ladders rail above the top rung of the ladders fly, the Base 11, locates the Extension 12 when it is in use, the Dock 9, locates the Extension when it is not in use.

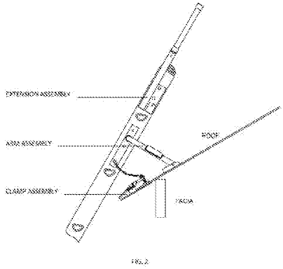

FIG. 8

Collapsed Extension Assy.

While the present invention has been described above in terms of specific, preferred embodiment, it is to be understood that the invention is not limited to these disclosed embodiments. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

A ladder stabilization apparatus that is composed of 3 assemblies, each assembly is reliant on the other, to achieve invention objectives.

What is claimed:

1. Arm assemblies, right and left: Each Arm assembly, being aluminum, steel, composite, or plastic in nature, is composed of a backing plate and a mounting plate that are bolted to the ladder frame below the top rung, attached to the mounting plate is a tubular arm, that has a bend that allows it to face the platform or roof and be perpendicular to the ladder. Attached to the arm is a 1″, 90°, Clamp Dock, positioned so as to rise above the top of the Arm. Also, on the Arm is a hole at its very end, said hole is horizontal. Attached at this horizontal hole by way of a ¼″ pin, is a foot, being aluminum, composite or plastic, and tubular in nature, said Foot is counterbalanced so the back dangles well below the pin, foot is beveled at its front and rear.

2. Clamp assemblies, right and left. Each Clamp assembly, being steel, aluminum, steel, composite, or plastic in nature, is composed of a common hold down clamp, that is to have Base plate affixed at the bottom of said clamp, an elevator bolt, affixed to the arm of said clamp by common hardware, and a pad at the lower end of said elevator bolt. Also, attached to the elevator bolt is a common chain, with its other end to be attached by common hardware to the Arm assembly at the lower end of the Mounting Plate.

3. Extension assembly. Being aluminum, steel, composite, or plastic in nature, is composed of a mounting plate that bolts to the ladders fly section, above the top rung, attached to said mounting plate is a short tube, located at a lower corner of the mounting plate, said tube is to have a hole in its center for pin location, as well as a notch at its top. Also attached to the mounting plate is a long tube, located on the upper portion of the mounting plate extending beyond the mounting plate, it is to have a hole below its top, for pin location, as well as a notch at its top. Another component is an independent long tube that will be secured to either of the above mentioned, welded tubes by way of a common ¼″ pin. This independent tube is to include a hole above its lower end, for pin location, and a collar, located above the hole, secured by way of a weld at the lower end of the collar, this weld will interact with the above continued on next page mentioned notches and serve to correctly locate the independent tube on insertion into either of the above mentioned welded tubes. Also welded to the independent tube is a 2^{nd}, collar, its location is to be at the top end of the tube.
